(19) United States
(12) Patent Application Publication
(10) Pub. No.: US 2008/0036110 A1
(43) Pub. Date: Feb. 14, 2008

(54) FOAM IN PLACE SEAT CUSHION USING DUAL FABRIC TRIM COVER AND FEATURELESS TOOL

(76) Inventors: David Brooker, LaSalle (CA); Larry F. Demoe, Harrow (CA); David Lang, Amherstburg (CA); Joseph Paquette, Amherstburg (CA)

Correspondence Address: MAGNA INTERNATIONAL, INC., 337 MAGNA DRIVE, AURORA, ON, L4G-7K1, US

(21) Appl. No.: 11/838,362

(22) Filed: Aug. 14, 2007

Related U.S. Application Data
(60) Provisional application No. 60/837,480, filed on Aug. 14, 2006.

(51) Int. Cl. B29C 39/20

(52) U.S. Cl. 264/46.8; 425/388

(57) ABSTRACT

A method of fabricating a plurality of seat elements is provided. The plurality of seat elements are styled to have a range of styling features. The method includes a step of determining the range of styling feature by selecting characteristics of a middle ply of foam and/or the exterior ply of the trim cover and selecting a number and position of panels that are sewn to form the trim cover. The seat elements are fabricated on a common mold apparatus.

This application claims the benefits of U.S. Provisional Application No. 60/837,480, filed Aug. 14, 2006.

### FIELD OF THE INVENTION

The present invention relates to seat assemblies for a motor vehicle. More particularly, the invention relates to a seat element having a foam body bonded with a trim cover.

### DESCRIPTION OF THE RELATED ART

A seat assembly includes a seat cushion and seat back for supporting an occupant within a motor vehicle. One method for the fabrication of the each seat element (seat cushion or seat back) includes the formation of a foam body within a trim cover, using a foam-in-place process. This process is well known in the art and fully described in U.S. Pat. Nos. 4,964,794; 5,098,270; 5,107,576; 5,231,746; 5,324,462; 5,466,404; 5,468,434; 5,614,226; and 6,994,812.

During the process, the trim cover is placed into a mold cavity having a predetermined shape. The mold cavity includes a mold surface defining the mirror image of the supporting surface of the seat cushion or scat back and also any design features to be included on the supporting surface. The material of the trim cover includes an exterior surface ply of fabric, a middle ply of foam material, and an imperforate interior surface ply. The imperforate interior surface ply allows the trim cover to be drawn into conformity with the mold surface by a vacuum. Thereafter, an expandable foam substrate is poured or injected into the mold cavity wherein the foam substrate undergoes a chemical reaction thereby causing the foam substrate to expand, solidify and adhere to the interior surface of the trim cover.

If a plurality of segments of material is used for the trim cover thereby creating seams, an imperforate tape must be used along the seams in sealed relation with the imperforate interior surface ply. The imperforate tape seals the seams allowing the trim cover to be drawn into conformity with the mold surface by the vacuum without the danger of the vacuum drawing unwanted portions of the foam substrate through the seams between the segments of material, which could result in undesired hard spots in the completed seat cushion or seat back.

The foam-in-place process has been utilized very successfully for many years for the manufacture of seats for the Chrysler minivan. The disadvantage of the foam-in-place process is that each time a refreshed or new styling is implemented new molds are required to be manufactured. The design and styling features of the seat element are defined by the mold surface; each seat element having different design features requires a different mold, thus adding significant cost to the production

Further, if different design features are implemented for the same model year, additional molds must be manufactured. If different molds are utilized then the first set of molds must be removed from the production line and a second set of molds must be installed before the seats with a second styling can be produced. With just-in-time delivery to the customer, this staged production requires an inventory of seats to be produced so that there are sufficient stocks of each type of seat available for delivery to the customer. Additional inventory adds costs to the production of the seats.

Heretofore, leather seats were not suitable for production with a foam-in-place method. To maintain sufficient quality in leather seats, a more traditional method of providing pre-formed foam buns and covering the foam buns with sewn leather covers was utilized. This separate production added costs for the program.

Therefore, it would be desirable to provide a seat element, and a method of fabricating a seat element, having specific design features determined by the construction of the trim cover itself rather than the mold surface of the mold, enabling a fill range of seating to be manufactured from a single set of tooling.

### SUMMARY OF THE INVENTION

According to one aspect of the invention, there is provided a method of fabricating a plurality of seat elements with a common mold assembly comprising an upper mold portion and a lower mold portion. The method comprising the steps of:

providing a lower mold portion having a lower mold surface contoured to define an occupant support surface between side bolters;

providing a trim cover having a plurality of panels sewn together, at least one of the panels comprising at least two plies of material including an exterior ply and a middle ply of foam;

positioning the trim cover onto the lower mold surface;

applying an imperforate film on the trim cover;

closing the mold assembly to define a mold cavity therebetween and retain the trim cover relative to said lower mold portion;

applying a negative pressure between the lower mold surface and the imperforate film so as to conform the trim cover and the imperforate film to the lower mold surface;

pouring a charge of foam substrate into the mold cavity and allowing the charge to cure and form a foam body and bond at least a portion of the trim cover to the foam body; and

removing the foam body with the trim cover bonded thereto from the mold cavity.

The plurality of seat elements are styled to have a range of styling features. The method includes a step of determining the range of styling feature by selecting characteristics of the middle ply of foam and selecting a number and position of the plurality of panels.

According to another aspect of the invention, there is provided an apparatus for fabricating a plurality of seat elements. The apparatus includes an upper mold portion and a lower mold portion. The upper mold portion being movable relative to said lower mold portion to define a mold cavity therebetween. The lower mold portion has a lower mold surface contoured to define an occupant support surface between side bolters and a ridge between said occupant support surface and each of said side bolsters.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a seat assembly including a seat element having a trim cover according to a first embodiment of the invention;

FIG. 2 is a perspective view of a featureless foam body for use with the seat element;

FIG. 3 is a cross-section view of the seat element including the foam body, an imperforate urethane film, and the trim cover;

FIG. 4 is a perspective view of a mold assembly in an open position;

FIG. 5 is a perspective view of the mold assembly in the open position including the trim cover and imperforate urethane film laid onto a lower mold surface;

FIG. 6 is a cross-sectional view of the mold assembly in a closed position; and

FIG. 7 is a cross-section view of an alternative embodiment of the seat element including the foam body, an imperforate urethane film, and the trim cover.

### DETAILED DESCRIPTION OF THE PREFERRED EMBODIMENTS

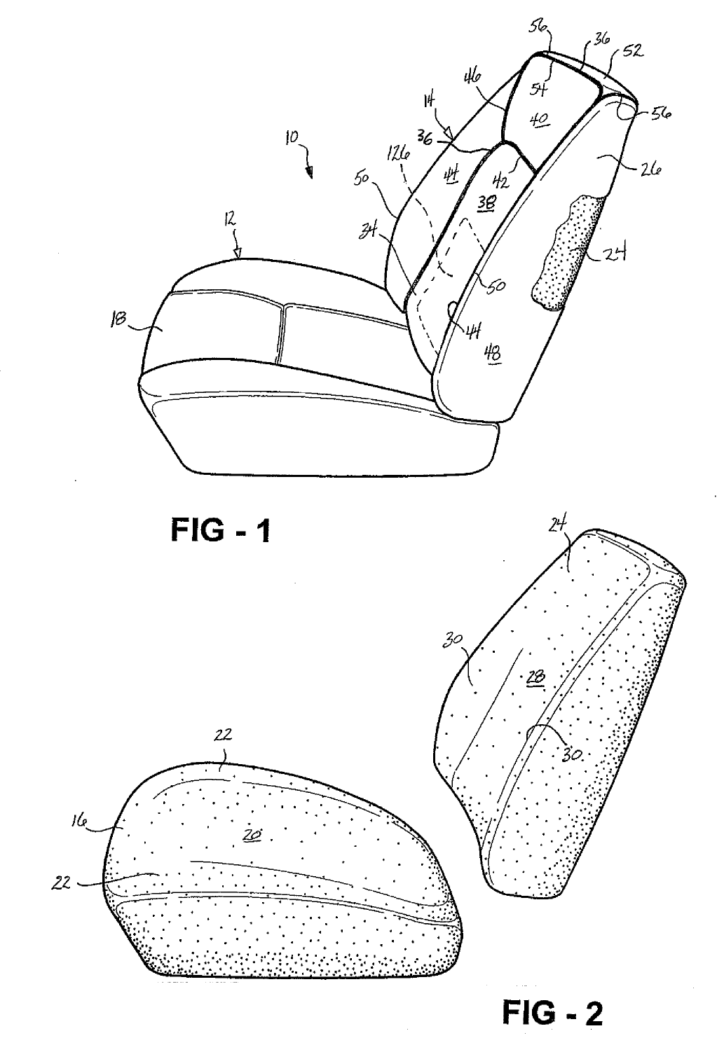

Referring to FIGS. 1 and 2, a seat assembly for use in a motor vehicle is generally shown at 10. The seat assembly 10 includes two seat elements, namely a seat cushion 12, and a seat back 14. The seat cushion 12 includes a conventional frame structure (not shown) for supporting a foam body 16 having a trim cover 18. In the preferred embodiment the foam body 16 of the seat cushion 12 is formed with a seating surface 20 between integral side bolsters 22.

Similarly, the seat back 14 includes a frame structure (not shown) for supporting a foam body 24 having a trim cover 26. The frame structure of the seat back 14 is pivotally coupled to the frame structure of the seat cushion 12 for providing selective angular adjustment of the seat back 12 between a plurality of reclined seating positions. In the preferred embodiment the foam body 24 of the seat back 14 is formed with a supporting surface 28 between integral side bolsters 30.

The seat elements may be fabricated using the same foam-in-place process as described below. Therefore, while the following description applies to the seat back 14 and the method of fabrication of the seat back 14, it will be understood that the description also applies to the seat cushion 12 and the method of fabrication of the seat cushion 12.

The trim cover 26 includes an occupant-engaging panel 34, bonded with the supporting surface 28 of the foam body 24. The occupant-engaging panel 34 includes two segments 38, 40 joined together, providing a contrasting appearance along an elongated styling line 42. In the embodiment shown, the two segments 38, 40 are sewn together, although other methods known to one skilled in the art may be used.

Bolster panels 44 are sewn to the occupant-engaging panel 34 along adjacent vertical edges 46 of the periphery 36 and are also bonded with the integral side bolsters 30 of the foam body 24. Side panels 48 are sewn to the bolster panels 44 along an exterior edge 50. A top panel 52 is sewn to the occupant-engaging panel 34 along an upper horizontal edge 54 of the periphery 36 and to the bolster panels 44 along upper edges 56.

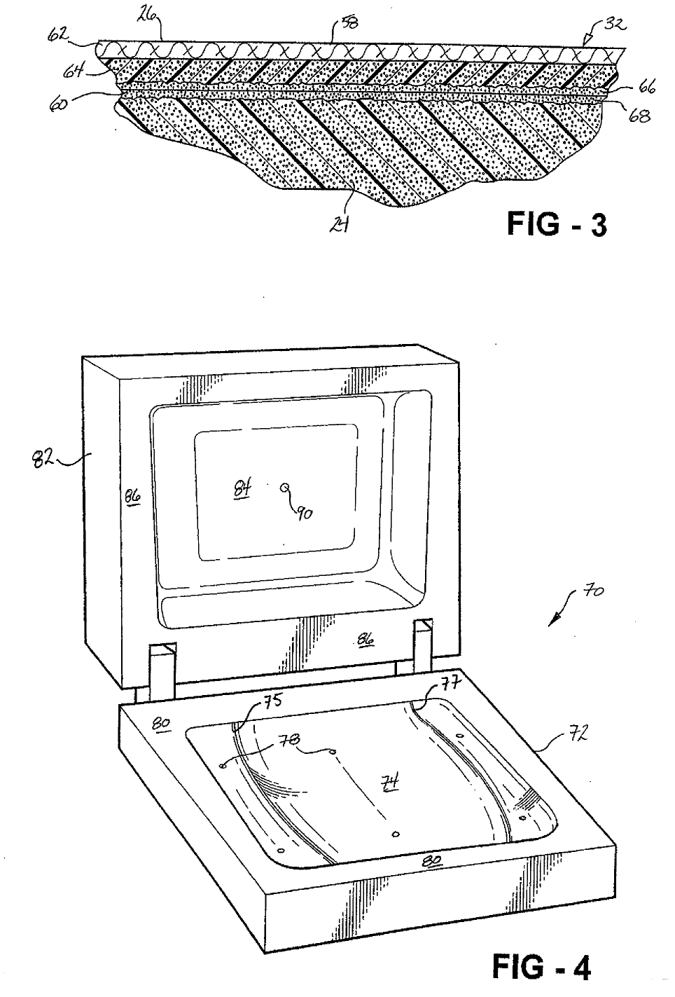

Referring to FIG. 3, a three-ply material 32 forming each panel of the trim cover 26 extends between an exterior surface 58 and an interior surface 60. An exterior ply 62 of the three-ply material 32 can be a woven fabric, a non-woven fabric, leather, vinyl, or a combination thereof to provide the required color, texture, or both to the exterior surface 58.

A middle ply 64 of urethane foam is laminated to the exterior ply 62. The type, thickness and density of the urethane foam can be selected to vary the degree of comfort that is to be provided. The foam can be closed cell foam, such as memory foam or open cell foam.

An inner ply 66 of a thermally activated adhesive film is laminated to the middle ply 64 of polyurethane foam.

An imperforate urethane film 68, known by its trade name Shawmut, is disposed between the trim cover 26 and the foam body 24. A single, continuous piece of the imperforate urethane film 68 is disposed between the interior surface 60 of the occupant-engaging panel 34 and the supporting surface 28 of the foam body 24, and also between the interior surface 60 of the bolster panels 44 and the integral bolsters 30 of the foam body 24, defining a barrier therebetween. A bond between the inner ply 66 of the trim cover 26, the imperforate urethane film 68, and the foam body 24 is established during the foam-in-place process. Alternatively, the imperforate film 68 can be treated so that a portion of the trim cover 26 does not adhere to the foam body 24. This process enables a portion of the trim cover 26 to float relative to the foam body 24, which is particularly useful in avoiding wrinkles in the bolster panels 44, when the exterior ply 52 is leather.

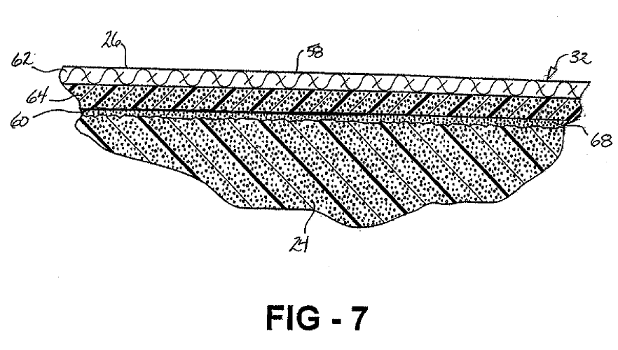

Alternatively as shown in FIG. 7, each panel of the trim cover 26 may include only the exterior ply 62 and the middle ply 64. In this particular embodiment of the present invention, the imperforate urethane film 68 includes an adhesive surface and is known by its trade name, Bemis. The adhesive surface of the imperforate urethane film 68 is adjacent to the interior surface 60 of the trim cover 26 when the imperforate urethane film 68 is either partially pre-bonded about the periphery 92 to the interior surface 60 of the trim cover 26 or when the imperforate urethane film 68 is laid onto the interior surface 60 of the trim cover 26. A bond between the middle ply 64 of the trim cover 26, the imperforate urethane film 68, and selectively at desired locations, the foam body 24 is established during the foam-in-place process.

The required panels of the trim cover 26 are sewn together without a bead or welting strip that is common in the prior art. The trim cover 26 and imperforate urethane film 68 are then placed in a mold assembly, generally shown at 70. As is now apparent, the seam between adjacent panels will create a styling line once the seat element has been formed. Thus, the seat designer has the option of adding or removing styling lines on the seat 10 element merely by adding or removing seams in the trim cover 26.

Referring to FIGS. 2 through 6, the mold assembly 70 includes a lower mold cast 72 defining a lower mold surface 74 shaped as the mirror image of the supporting surface 28 and integral side bolsters 30 of the foam body 24. It is important to note that the portion of the lower mold surface 74 for forming the supporting surface 28 of the foam body 24 is relatively featureless. In particular, the mold surface does not have grooves defining a separation line between the side bolsters 30 and the supporting surface 28. Featureless means that the lower mold cast 72 is configured to the complement of the basic contours of the seat element, namely occupant contact area, supporting surface 28, between side bolster 30. A simple smooth ridge or transitional line 75, 77 separate the areas that define the supporting surface 28 and the side bolsters 30. Therefore, any styling or design features to be provided on the seat back 14 are provided by the construction of the trim cover 26 itself. Thus, the mold assembly 70 can be used to fabricate any number of different seat backs 14 by varying the construction of the trim cover 26, in particular, by varying the design features provided by the trim cover 26.

A flexible component 126 is typically a heating unit or occupant sensor, but can be any component required to be included within the seat back 14. The heating unit 126 is molded-in-place between the supporting surface 28 of the foam body 24 and the imperforate urethane film 68. The heating unit 126 includes wires (not shown) extending from the seat back 14 for controlling the heating unit 126. The heating unit 126 also includes an adhesive surface 128 adjacent to the imperforate urethane film 68 for adhering the heating unit 126 to the imperforate urethane film 68 at the desired location within the periphery 36 of the occupant-engaging panel 34. The heating unit 126 may be adhered to the imperforate urethane film 68 using the adhesive surface 128 prior to, or subsequent to, laying the trim cover 26 and imperforate urethane film 68 onto the lower mold surface 74 of the mold assembly 70. Since the heating unit 126 is flexible the source of vacuum draws the trim cover 26, imperforate urethane film 68, and heating unit 126 into conformity with the lower mold surface 74. The adhesive surface 128 maintains the heating unit 126 at the desired location during the foam-in-place process and prevents the heating unit 126 from floating in the foam substrate before the foam substrate cures to form the foam body 24. The foam substrate fills the mold cavity 88 and is cured to form the foam body 24, resulting in the heating unit 126 being molded-in-place.

The lower mold cast 72 includes an interior passage or manifold system, generally indicated at 76, which communicates between the lower mold surface 74 and a vacuum source through a series of openings 78 extending therethrough. It will also be noted that the lower mold cast 72 includes an outer peripheral surface 80 surrounding the lower mold surface 74.

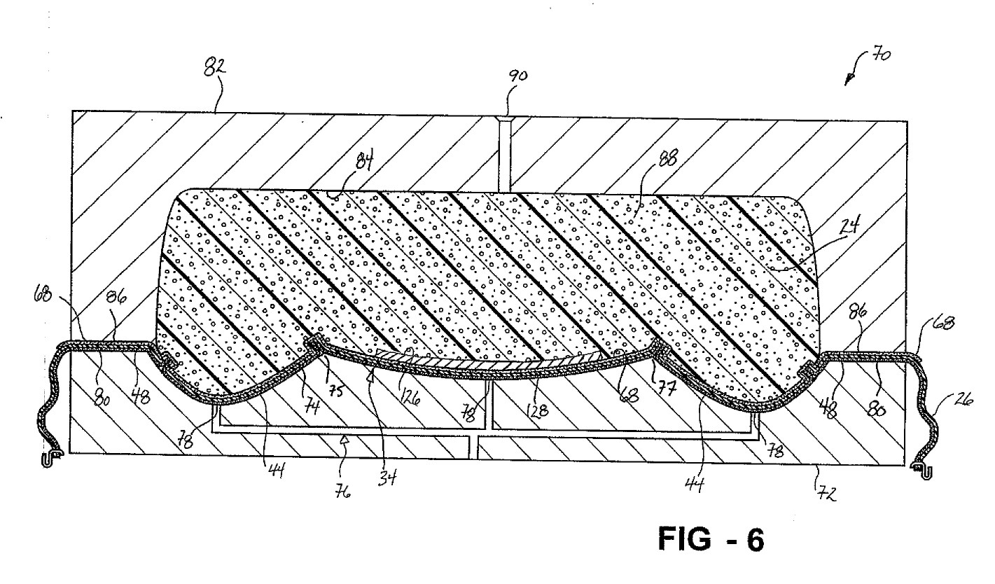

Mold assembly 74 also includes an upper mold cast 82 defining a substantially flat upper mold surface 84. The upper mold cast 82 is mounted for pivotal movement between an open position, shown in FIG. 4, and a closed position, shown in FIG. 6, in which a peripheral surface 86 surrounding the upper mold surface 84 is in sealing engagement with the peripheral surface 80 surrounding the lower mold surface 74. In the closed position, the upper mold cast 82 and lower mold cast 72 define a mold cavity 88 therebetween, wherein the foam-in-place process takes place. The upper mold cast 82 includes at least one foam substrate injector 90 extending through the upper mold cast 82 so as to communicate with the mold cavity 88 when the upper mold cast 82 is in the closed position.

A plurality of heat lines (not shown) within the upper mold cast 82 and the lower mold cast 72 are disposed adjacent to the respective upper and lower mold surfaces 84, 74 for providing heat to the mold cavity 88 during the foam-in-place process. The reaction that the foam substrate undergoes during the foam-in-place process in the mold cavity 88 is an exothermic reaction, which produces heat during the foam-in-place process.

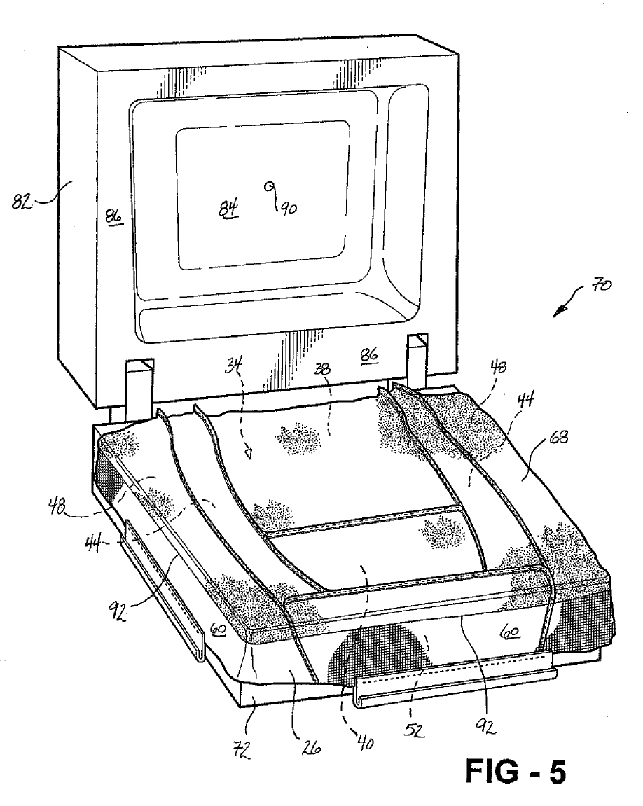

Prior to laying the trim cover 26 and imperforate urethane film 68 onto the lower mold surface 74 of the mold assembly 70, as shown in FIG. 5, the imperforate urethane film 68 may be partially pre-bonded about a periphery 92 of the imperforate urethane film 68 to the interior surface 60 of the trim cover 26. Pre-bonding the imperforate urethane film 68 to the trim cover 26 allows for ease of material handling and reduces the cycle time for loading the trim cover 26 and imperforate urethane film 68 onto the mold assembly 70.

With the upper mold cast 82 in the open position, a mold release agent, as is well known to one skilled in the art, is sprayed onto the upper and lower mold surfaces 84, 74 for preventing the trim cover 26 and the foam body 24 from sticking to the upper and lower mold surfaces 84, 74 after the foam-in-place process is complete. Subsequent to applying the mold release agent, the trim cover 26 with the imperforate urethane film 68 partially pre-bonded thereto is laid onto the lower mold surface 74 with the exterior surface 58 of the trim cover 26 adjacent to the lower mold surface 74. Alternatively, if the imperforate urethane film 68 is not partially pre-bonded to the interior surface 60 of the trim cover 26, the trim cover 26 is first laid onto the lower mold surface 74 with the exterior surface 58 adjacent to the lower mold surface 74 and then the imperforate urethane film 68 is laid onto the interior surface 60 of the trim cover 26.

A source of vacuum (not shown) is communicated with the manifold system 76 to create a negative pressure condition between the lower mold surface 74 and the imperforate urethane film 68, which draws the occupant-engaging panel 34 and bolster panels 44 of the trim cover 26 into conformity with the lower mold surface 74. The negative pressure also causes any design features and seams provided by the construction of the trim cover 26 to compress into conformity with the lower mold surface 74. Thereafter, the upper mold cast 82 is moved into the closed position, in which the peripheral surface 86 surrounding the upper mold surface 84 is in mating engagement with the peripheral surface 80 surrounding the lower mold surface 74, creating the mold cavity 88 therebetween. Panels of the trim cover 26 which are not bonded with the foam body 24 during the foam-in-place process extend from the mold cavity 88 and are disposed between the peripheral surface 86 surrounding the upper mold surface 84 and the peripheral surface 80 of the lower mold surface 74. In the embodiment shown, the occupant-engaging panel 34 and the bolster panels 44 are disposed within the mold cavity 88 for bonding with the foam body 24 during the foam-in-place process. The side panels 48 and top panel 52 extend from the mold cavity 88 and therefore will not be bonded with the foam body 24.

Next, a charge of the foam substrate is injected through the foam substrate injector 90 into the mold cavity 88. The mold cavity 88 is heated by circulating heated fluid through the plurality of heat lines within the upper and lower mold casts 82, 72. The heat and pressure from the mold assembly 70 initiates a chemical reaction of the foam substrate causing the foam substrate to fill the mold cavity 88, thereby forming the foam body 24. At the same time, the heat and pressure from the mold assembly 70 and the heat produced by the exothermic chemical reaction of the foam substrate causes the inner ply 66, or alternatively the middle ply 64, of the trim cover 26, the imperforate urethane film 68, and the foam body 24 to bond together.

After the foam body 24 has cured, the upper mold cast 82 is moved into the open position and the seat back 14 including the trim cover 26 bonded with the foam body 24 is removed from the mold assembly 70. The removal of the seat back 14 from the lower mold surface 74 allows any previously vacuum-compressed design features provided by the construction of the trim cover 26 to recover to their original shape. The side panels 48 and top panel 52 are then wrapped around the foam body 24 and fixedly secured thereto. Alternatively, the side panels 48 and top panel 52 are wrapped around the foam body 24 and a back panel (not shown) is sewn to the side panels 48 and top panel 52, enclosing the foam body 24 within the trim cover 26. It will be understood that, after the seat back 14 has been completed in the manner described above, it is then mounted to the frame structure and secured in its operative position.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed is:

1. A method of fabricating a plurality of seat elements with a common mold assembly comprising an upper mold portion and a lower mold portion, the method comprising the steps of:
providing a lower mold portion having a lower mold surface contoured to define an occupant support surface between side bolters;
providing a trim cover having a plurality of panels sewn together, at least one of said panels comprising at least two plies of material including an exterior ply and a middle ply of foam;
positioning the trim cover onto the lower mold surface;
applying an imperforate film on the trim cover;
closing the mold assembly to define a mold cavity therebetween and retain the trim cover relative to said lower mold portion;
applying a negative pressure between the lower mold surface and the imperforate film so as to conform the trim cover to the lower mold surface;
pouring a charge of foam substrate into the mold cavity and allowing the charge to cure and form a foam body and activate bond at least a portion of the trim cover to the foam body; and
removing the foam body with the trim cover bonded thereto from the mold cavity,
whereby said plurality of seat elements are styled to have a range of styling features and said method includes a step of determining said range of styling feature by selecting characteristics of said exterior ply and said middle ply of foam and selecting a number and position of said plurality of panels.

2. A method of fabricating a plurality of seat elements as set forth in claim 1 wherein said lower mold surface has a smooth ridge between said occupant support surface and each of said side bolsters.

3. A method of fabricating a plurality of seat elements as set forth in claim 2 wherein said characteristics of said middle ply of foam include thickness, density and type of foam.

4. A method of fabricating a plurality of seat elements as set forth in claim 3 wherein said exterior ply is selected from a group comprising woven fabric, non-woven fabric, leather and vinyl.

5. A method of fabricating a plurality of seat elements as set forth in claim 4 wherein the step of applying the imperforate film to the trim is prior to the step of positioning the trim cover onto the lower mold surface.

6. A method of fabricating a plurality of seat elements as set forth in claim 5 including a step of adhering a flexible component to the imperforate film at a desired location.

7. A method of fabricating a plurality of seat elements as set fort in claim 6 wherein said flexible component is a heating unit or an occupant sensor.

8. A method of fabricating a plurality of seat elements as set forth in claim 7 wherein said trim cover has at least two panels and said at least two panels arc positioned on said occupant support surface.

9. A method of fabricating a plurality of seat elements as set forth in claim 8 including a step of adhering a flexible component to one of the at least two panels.

10. A method of fabricating a plurality of seat elements as set forth in claim 9 wherein said flexible component is a heating unit or an occupant sensor.

11. A method of fabricating a plurality of seat elements as set forth in claim 1, wherein said trim cover has an inner ply of thermally active adhesive film.

12. A method of fabricating a plurality of seat elements as set forth in claim 11 wherein said characteristics of said middle ply of foam include thickness, density and type of foam.

13. A method of fabricating a plurality of seat elements as set forth in claim 12 wherein said exterior ply is selected from a group comprising woven fabric, non-woven fabric, leather and vinyl.

14. A method of fabricating a plurality of seat elements as set forth in claim 13 wherein the step of applying the imperforate film to the trim cover is prior to the step of positioning the trim cover onto the lower mold surface.

15. A method of fabricating a plurality of seat elements as set forth in claim 14 including a step of adhering a flexible component to the imperforate film at a desired location.

16. A method of fabricating a plurality of seat elements as set forth in claim 15 wherein said flexible component is a heating unit or an occupant sensor.

17. A method of fabricating a plurality of seat elements as set forth in claim 16 wherein said lower mold surface has a smooth ridge between said occupant support surface and each of said side bolsters.

18. An apparatus for fabricating a plurality of seat elements, said apparatus comprising an upper mold portion and a lower mold portion, said upper mold portion being movable relative to said lower mold portion to define a mold cavity therebetween, said lower mold portion having a lower mold surface smoothly contoured to define an occupant support surface between side bolters and a ridge between said occupant support surface and each of said side bolsters.
